(19) United States
(12) Patent Application Publication
(10) Pub. No.: US 2009/0086795 A1
(43) Pub. Date: Apr. 2, 2009

(54) METHOD AND SYSTEM FOR A LOW-COMPLEXITY VARIABLE FREQUENCY OSCILLATOR USING DIRECT DIGITAL FREQUENCY SYNTHESIS

(76) Inventors: Ahmadreza Rofougaran, Newport Coast, CA (US); Maryam Rofougaran, Rancho Palos Verdes, CA (US)

Correspondence Address: MCANDREWS HELD & MALLOY, LTD, 500 WEST MADISON STREET, SUITE 3400, CHICAGO, IL, 60661, US

(21) Appl. No.: 11/864,750

(22) Filed: Sep. 28, 2007

(51) Int. Cl. H04L 25/00; H04L 27/00

(52) U.S. Cl. 375/216; 341/144

(57) ABSTRACT

Aspects of a method and system for a low-complexity variable frequency oscillator using direct digital frequency synthesis may include generating one or more digital output signals via a Direct Digital Frequency Synthesizer (DDFS) that may be clocked by a high frequency clock signal. The one or more generated digital output signals may be converted into an analog signal via a Digital-to-Analog Converter (DAC), wherein the analog signal comprises at least a local oscillator signal and a corresponding frequency image signal, and the DAC is clocked by the high frequency clock signal. A low-frequency output local oscillator signal may be generated by bandpass filtering the analog signal in a single-pole bandpass filter, the single-pole bandpass filter may be configured to retain the local oscillator signal component of the analog signal. An effective capacitance and/or an effective inductance of the single-pole bandpass filter may be programmably adjusted.

### CROSS-REFERENCE TO RELATED APPLICATIONS/INCORPORATION BY REFERENCE

[Not Applicable]

### FIELD OF THE INVENTION

Certain embodiments of the invention relate to signal processing for communication systems. More specifically, certain embodiments of the invention relate to a method and system for a low-complexity variable frequency oscillator using direct digital frequency synthesis.

### BACKGROUND OF THE INVENTION

A Direct Digital Frequency Synthesizer (DDFS) is a digitally-controlled signal generator that may vary the output signal frequency over a large range of frequencies, based on a single fixed-frequency precision reference clock. In addition, a DDFS is also phase-tunable. In essence, within the DDFS, discrete amplitude levels are fed to a Digital-to-Analog Converter (DAC) at a sampling rate determined by the fixed-frequency precision reference clock. The output of the DDFS provides a signal whose shape depends on the sequence of discrete amplitude levels that are fed to the DAC at the constant sampling rate. The DDFS is particularly well suited as a frequency generator that outputs a sine or other periodic waveforms over a large range of frequencies, from almost DC to approximately half the fixed-frequency reference clock frequency.

A DDFS offers a larger range of operating frequencies and requires no feedback loop, thereby providing near instantaneous phase- and frequency changes, avoiding over- and undershooting and settling time issues associated with another analog systems. A DDFS may provide precise digitally-controlled frequency and/or phase changes without signal discontinuities.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for a low-complexity variable frequency oscillator using direct digital frequency synthesis (DDFS), substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary wireless communication system, in accordance with an embodiment of the invention.

FIG. 2A is a block diagram illustrating a variable frequency oscillator, in accordance with an embodiment of an invention.

FIG. 2B is a frequency diagram illustrating an exemplary local oscillator system, in accordance with an embodiment of the invention

FIG. 3 is a circuit diagram illustrating an exemplary embodiment of a programmable bandpass filter 300, in accordance with an embodiment of the invention.

FIG. 4 is a flow chart, illustrating an exemplary adjustment process of a variable frequency oscillator, in accordance with an embodiment of the invention.

### DETAILED DESCRIPTION OF THE INVENTION

Certain embodiments of the invention may be found in a method and system for a low-complexity variable frequency oscillator using direct digital frequency synthesis. Aspects of a method and system for a low-complexity variable frequency oscillator using direct digital frequency synthesis may comprise generating one or more digital output signals via a Direct Digital Frequency Synthesizer (DDFS) that may be clocked by a high frequency clock signal. The one or more generated digital output signals may be converted into an analog signal via a Digital-to-Analog Converter (DAC), wherein the analog signal comprises at least a local oscillator signal and a corresponding frequency image signal, and the DAC is clocked by the high frequency clock signal. A low-frequency output local oscillator signal may be generated by bandpass filtering the analog signal in a single-pole bandpass filter, the single-pole bandpass filter may be configured to retain the local oscillator signal component of the analog signal.

An effective capacitance and/or an effective inductance of the single-pole bandpass filter may be programmably adjusted. The single-pole bandpass may be a differential signal filter, and the low-frequency output local oscillator signal may be generated as a differential signal. The high frequency associated with said clock signal may be at least 10 times higher than a fundamental frequency of the local oscillator signal associated with the low-frequency output local oscillator signal. The low-frequency output signal may be sinusoidal or may comprise an arbitrary pulse-shape. A frequency of said local oscillator signal may be dynamically adjusted. The bandpass filter may comprise microstrip filters. To generate the clock signal, a phase-locked loop may be used.

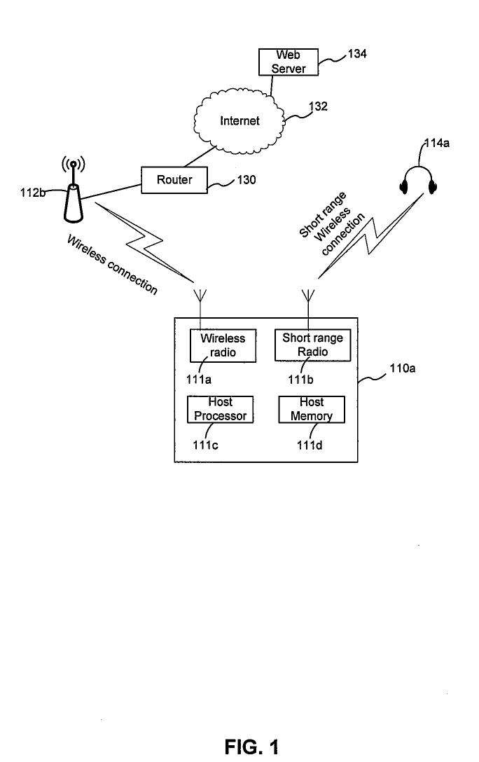

FIG. 1 is a diagram illustrating an exemplary wireless communication system, in accordance with an embodiment of the invention. Referring to FIG. 1, there is shown an access point 112b, a computer 110a, a headset 114a, a router 130, the Internet 132 and a web server 134. The computer or host device 110a may comprise a wireless radio 111a, a short-range radio 111b, a host processor 111c, and a host memory 111d. There is also shown a wireless connection between the wireless radio 111a and the access point 112b, and a short-range wireless connection between the short-range radio 111b and the headset 114a.

Frequently, computing and communication devices may comprise hardware and software to communicate using multiple wireless communication standards. The wireless radio 111a may be compliant with a mobile communications standard, for example. There may be instances when the wireless radio 111a and the short-range radio 111b may be active concurrently. For example, it may be desirable for a user of the computer or host device 110a to access the Internet 132 in order to consume streaming content from the Web server 134. Accordingly, the user may establish a wireless connection between the computer 110a and the access point 112b. Once this connection is established, the streaming content from the Web server 134 may be received via the router 130, the access point 112b, and the wireless connection, and consumed by the computer or host device 110a.

It may be further desirable for the user of the computer 110a to listen to an audio portion of the streaming content on the headset 114a. Accordingly, the user of the computer 110a may establish a short-range wireless connection with the headset 114a. Once the short-range wireless connection is established, and with suitable configurations on the computer enabled, the audio portion of the streaming content may be consumed by the headset 114a. In instances where such advanced communication systems are integrated or located within the host device 110a, the radio frequency (RF) generation may support fast-switching to enable support of multiple communication standards and/or advanced wideband systems like, for example, Ultrawideband (UWB) radio or Bluetooth®. Other applications of short-range communications may be wireless High-Definition TV (W-HDTV), from a set top box to a video display, for example. W-HDTV may require high data rates that may be achieved with large bandwidth communication technologies, for example UWB and/or 60-GHz communications.

In instances where, for example, 60-GHz communications may be integrated in the computer 110a, a generated high-frequency clock signal that may be used for the generation of the short-range wireless connection via the short-range radio 111b may be enabled to generate lower frequency signals that may be enabled to assist generation of RF signals in the wireless radio 111a, in accordance with an embodiment of the invention.

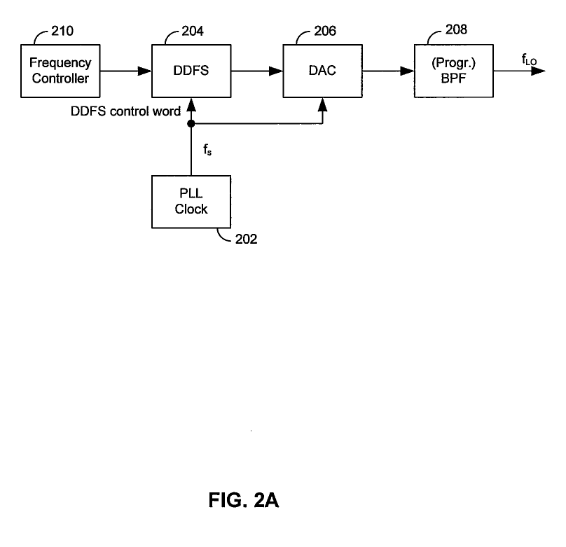

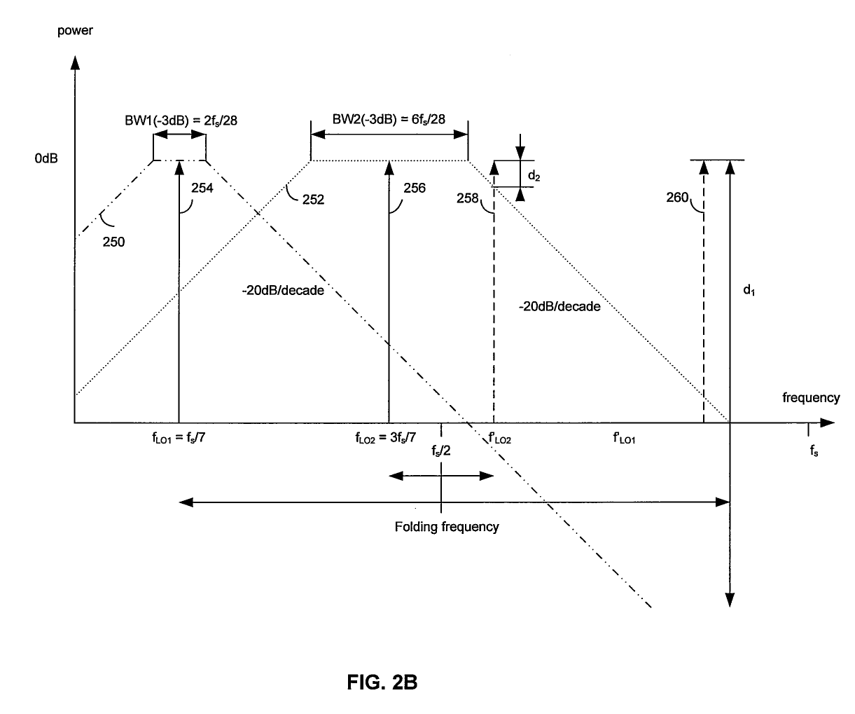

FIG. 2A is a block diagram illustrating a variable frequency oscillator, in accordance with an embodiment of an invention. Referring to FIG. 2A, there is shown a Phase Locked Loop (PLL) clock 202, a Direct Digital Frequency Synthesizer (DDFS) 204, a Digital-to-Analog Converter (DAC) 206, a programmable bandpass filter (BPF), and a Frequency Controller 210. There is also shown a clocking frequency fs and a local oscillator frequency fLO.

The PLL clock 202 may comprise suitable logic, circuitry and/or code that may be enabled to generate a clock output, fs. The DDFS 204 may comprise suitable logic, circuitry and/or code that may be enabled to generate a digital data word at its output that may be proportional to a variable phase and frequency. The DDFS 204 may be controlled via the frequency controller 210 that may comprise suitable logic, circuitry and/or code to generate a control word that may be used to define the output of the DDFS 204. The digital output of the DDFS 204 may be communicatively coupled to the DAC 206, which may comprise suitable logic, circuitry and/or code to convert a digital input word into an analog output signal. The analog output signal may then be fed to a programmable BPF 208 that may comprise suitable logic, circuitry and/or code to generate the local oscillator signal fLO. The DDFS 204 and the DAC 206 may be clocked by the PLL clock 210. The PLL clock 202 may generate a clock signal fs>fLO. The output frequency fLO that may be generated at the output of the programmable BPF 208 may be as high as fs/2.

Technologies such as 90 nanometer CMOS manufacturing may enable the use clock frequencies fs>60 GHz. This may permit to generate local oscillator signal fLO that may be enabled to clock a wide variety of high-frequency components. In accordance with an embodiment of this invention, the high clocking frequency fs may permit the usage of reduced-complexity bandpass filters.

FIG. 2B is a frequency diagram illustrating an exemplary local oscillator system, in accordance with an embodiment of the invention. Referring to FIG. 2B, there is shown frequency characteristics of bandpass filters 250 and 252, local oscillator frequencies fLO1 254 and fLO2 256, and frequency images fLO1 258 and fLO2 260. The local oscillator signals may be sinusoidal, for example. There is also indicated clocking frequency fs, folding frequency fs/2, attenuation d1 and d2, 3-dB bandwidth of bandpass filter 250 BW1 and 3-dB bandwidth of bandpass filter 252 BW2.

By the sampling theorem, digital signals generated or sampled at the frequency fs may only be converted back to analog signals unambiguously if the highest frequency component may not exceed fs/2, the folding frequency. Although the sampling theorem may specify the optimal interpolation function to convert a digital signal to an analog signal by employing sinc interpolation, it may be too complex or costly to do so in many practical systems. In these instances, a system may employ, for example, a zero-order hold interpolation, which may simply hold the analog output of the DAC, for example DAC 206, constant until the next sample may be received. Other interpolations like linear interpolation may also be used and the present invention shall not be limited to any one particular method of interpolation. In general, practical digital-to-analog systems may result in generating some frequency components above the folding frequency. These frequency components may typically be undesirable and may be attenuated by the programmable bandpass filter 208.

A bandpass filter may, for example, be characterized by its quality factor, or Q factor. The Q factor may be defined by Q=fc/BW, where fc may be the center frequency of the filter, and BW the bandwidth of the filter at the 3-dB point. In general terms, the Q factor may be an indicator about the complexity to implement a filter. A high Q factor may be more complex to implement. The bandpass filter 250 and the bandpass filter 252 illustrated in FIG. 2B may both depict filters with a Q factor of 2. It may be observed that the bandwidth of the bandpass filter 252 may be significantly wider for the same Q factor, compared to bandpass filter 250, due to the different in center frequency. From the relationship given above, Q=fc/BW, it may be seen that a higher Q factor may be required to achieve the same bandwidth at a higher center frequency, which may require a more complex filter implementation. Furthermore, the bandpass filters 250 and the bandpass filter 252 may both be depicted with 20 dB of attenuation per decade. A steeper slope, and hence better out-of-band attenuation may be achieved by implementing more complex higher order filters, for example, Chebyshev or Butterworth filters.

A digital-to-analog conversion, for example DAC 208 may generate frequencies above the folding frequency fs/2. These frequencies may occur at frequencies that may be the desired frequency folded at the folding frequency, thence the name. These frequencies may be referred to as frequency images. For example, a desired local oscillator frequency fLO2, may result in a frequency image at f′LO2, where the frequencies fLO2 and fLO2 are separated from the folding frequency by the same distance in frequency. Similarly, a local oscillator frequency fLO1 may generate a frequency image f′LO1.

The frequency images may be undesirable and may be filtered out. As may be seen in FIG. 2B, the bandpass filter 254 may attenuate the frequency image f′LO1 260 of the local oscillator frequency fLO1 254 strongly, as is indicated by the attenuation d1. On the other hand, the frequency image fLO2 258 of the local oscillator frequency fLO2 256 may not be well attenuated by bandpass filter 252, as is indicated by the attenuation d2, even though both bandpass filters 250 and 252 may have an identical Q factor.

The difference in attenuation between d1 and d2 may be due to various factors primarily. For example, the difference may be due to a difference in the absolute frequency between fLO1 and fLO2. In some instances, it may be advantageous to generate lower local oscillator frequencies fLO with respect to filtering requirements, where this may be possible. Furthermore, the separation between fLO1 254 and its image f′LO1 260 may be significantly larger than the separation between fLO2 256 and fLO2 258. In instances where the bandwidth BW2 may be equal to bandwidth BW1, the attenuation d2 may still be smaller than d1. To obtain the same attenuation for fLO2 258 as may be obtained for f′LO1 260, the bandpass filter 252 may require a smaller 3-dB bandwidth BW2 (which may be obtained through a higher Q filter) and steeper out-of-band attenuation slopes (which may be obtained through higher order filters). Both requirements may make the bandpass filter 252 complex to implement. However, as seen from fLO1 254 and f′LO1 260, by increasing the separation in frequency between the fLO2 and f′LO2, a much better attenuation may be obtained with a bandpass filter, for example a single-pole filter. A larger frequency separation may be achieved by increasing the frequency fs and hence move away the folding frequency fs/2 from fLO2 256.

Due to recent advances in semiconductor fabrication technology, it may be possible to achieve clocking frequencies fs>60 GHz. These high frequencies may enable an embodiment of the invention to generate, for example, clock signals, modulation carriers and data modulated signals for most current wireless technologies. The invention shall, however, not be limited to applications in wireless communications.

For example, a fs=60 GHz may be used to generate RF signals for ISM band applications like, but not limited to, Bluetooth or Wireless LAN. These technologies may be enabled to employ center frequencies of approximately fLO=2.4 GHz=fs/25. A frequency image may hence be found at approximately f′LO=57.6 GHz. A simple pole filter with 20 dB/decade of attenuation may enable well over 20 dB attenuation at frequencies greater than 24 GHz. Indeed, for any frequency approximately fLO<5.45 GHz, a simple pole bandpass filter may offer approximately 20 dB or more of attenuation at the frequency image f′LO, for example. By implementing the bandpass filter 208 in programmable form, the bandpass filter 208 may be adapted to implement, for example, a variety of wireless communication protocols.

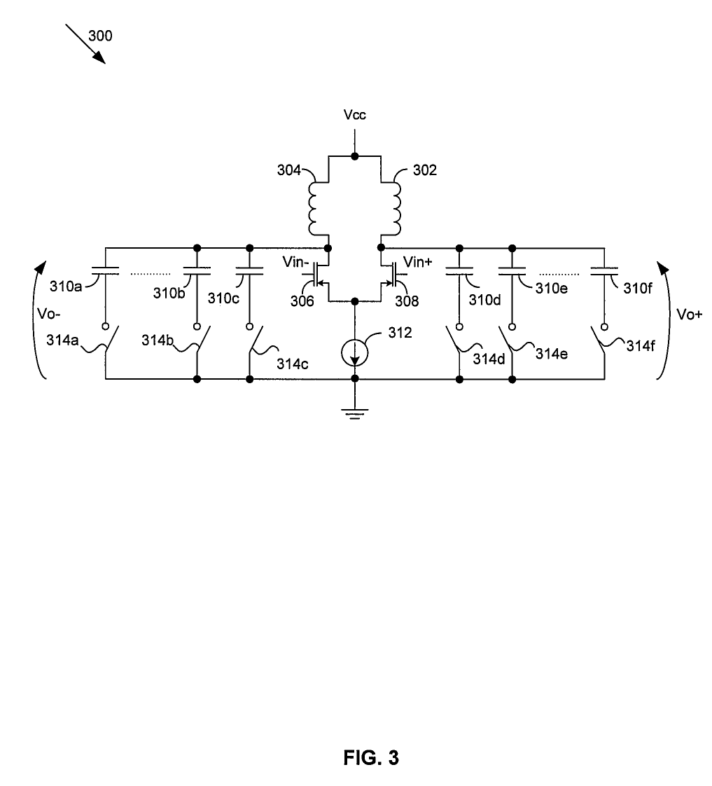

FIG. 3 is a circuit diagram illustrating an exemplary embodiment of a programmable bandpass filter 300, in accordance with an embodiment of the invention. Referring to FIG. 3, there is shown inductances 302 and 304, field-effect transistors (FETS) 306 and 308, a plurality of capacitances, of which capacitances 310a through 310f may be illustrated, a plurality of switches, of which switches 314a through 314f may be illustrated, and a current source 312. There is also shown a supply voltage Vcc, differential input voltages Vin+ and Vin−, and differential output voltages Vo+ and Vo−.

The circuit depicted in FIG. 3 may be one embodiment of an active single pole filter that may exhibit bandpass characteristics. In accordance with an embodiment of the invention, a bandpass filter 300 may illustrate an embodiment of a suitable bandpass filter 208. The center frequency of the bandpass filter 300 may be programmable by closing a desirable set of switches from the plurality of switches, for example switches 314a through 314f. Setting a desirable combination of switches may change the effective capacitance formed by the plurality of capacitances, for example capacitances 310a through 310f. The bandwidth of the bandpass filter 300 may be adjusted by choosing inductors 302 and 304 with a desirable quality factor Q, for example. The current source 312 may comprise suitable logic, circuitry and/or code that may be enabled to generate an approximately constant current, regardless of the voltage applied across its terminals.

A differential input voltage may be applied between the input terminals Vin+ and Vin−. The FETs 306 and 308 may be enabled to generate a current that may be proportional to the input voltage applied, which may result to a differential output voltage between the output terminals Vo+ and Vo−. Due to the bandpass filtering characteristics of the combination of the inductances 302 and 304 with the plurality of capacitances 310a through 310f, the output voltages Vo+ and Vo− may be effectively grounded at low and high frequencies and may suitably amplify the input signal applied at Vo+ and Vo− in a relatively narrow range of frequencies.

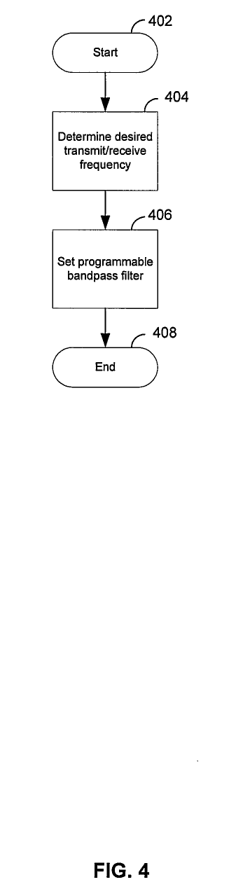

FIG. 4 is a flow chart, illustrating an exemplary adjustment process of a variable frequency oscillator, in accordance with an embodiment of the invention.

A variable frequency oscillator may be adjusted to generate local oscillator signals for various applications, for example different mobile telephony transmission and/or reception frequencies, or IEEE 802.11 Wireless Local Area Networks. In these instances, in step 404, the selected channel or desired transmission or reception frequency may determine the target frequency to be generate in the DDFS, for example DDFS 204. In some instances, the pulse-shape of the desired signal may also be determined as a function of the desired application. In step 406, a bandpass filter, for example a programmable bandpass filter 208, may be adjusted for a desirable center frequency and a desirable bandwidth, in accordance with the desired output frequency. Other parameters of the filter may be adjusted, for example a gain.

In accordance with an embodiment of the invention, a method and system for a a low-complexity variable frequency oscillator using direct digital frequency synthesis may comprise generating one or more digital output signals via a Direct Digital Frequency Synthesizer (DDFS), for example DDFS 204, that may be clocked by a high frequency clock signal, for example generated by the PLL clock 202. The one or more generated digital output signals may be converted into an analog signal via a Digital-to-Analog Converter (DAC), for example DAC 206, wherein the analog signal comprises at least a local oscillator signal and a corresponding frequency image signal, and the DAC is clocked by the high frequency clock signal, as described for FIG. 2A and FIG. 2B. A low-frequency output local oscillator signal, for example fLO may be generated by bandpass filtering the analog signal in a single-pole bandpass filter, for example bandpass filter 300 or bandpass filter 208, the single-pole bandpass filter may be configured to retain the local oscillator signal component of the analog signal, as illustrated in FIG. 2B.

An effective capacitance and/or an effective inductance of the single-pole bandpass filter may be programmably adjusted, as illustrated in FIG. 3. The single-pole bandpass may be a differential signal filter, for example like bandpass filter 300, and the low-frequency output local oscillator signal may be generated as a differential signal, generated from Vo+ and Vo−, as described for FIG. 3. The high frequency associated with said clock signal, for example fs, may be at least 10 times higher than a fundamental frequency of the local oscillator signal associated with the low-frequency output local oscillator signal, for example fLO. The low-frequency output signal may be sinusoidal or may comprise an arbitrary pulse-shape, as enabled by the DDFS 204. A frequency of said local oscillator signal may be dynamically adjusted, for example by the frequency controller 210. The bandpass filter may comprise microstrip filters, as described for FIG. 3. To generate the clock signal, a phase-locked loop may be used, as illustrated in FIG. 2A.

Another embodiment of the invention may provide a machine-readable storage, having stored thereon, a computer program having at least one code section executable by a machine, thereby causing the machine to perform the steps as described above for a method and system for a low-complexity variable frequency oscillator using direct digital frequency synthesis.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing communication signals, the method comprising:
generating one or more digital output signals via a Direct Digital Frequency Synthesizer (DDFS) that is clocked by a high frequency clock signal;
converting said one or more generated digital output signals into an analog signal via a Digital-to-Analog Converter (DAC), wherein said analog signal comprises at least a local oscillator signal and a corresponding frequency image signal, and said DAC is clocked by said high frequency clock signal; and
generating a low-frequency output local oscillator signal by bandpass filtering said analog signal in a single-pole bandpass filter, said single-pole bandpass filter is configured to retain said local oscillator signal component of said analog signal.

2. The method according to claim 1, comprising programmably adjusting an effective capacitance and/or an effective inductance of said single-pole bandpass filter.

3. The method according to claim 1, wherein said single-pole bandpass filter is a differential signal filter.

4. The method according to claim 3, comprising generating said low-frequency output local oscillator signal as a differential signal.

5. The method according to claim 1, wherein said high frequency associated with said clock signal is at least 10 times higher than a fundamental frequency of said local oscillator signal associated with said low-frequency output local oscillator signal.

6. The method according to claim 1, wherein said low-frequency output signal is sinusoidal.

7. The method according to claim 1, wherein said low-frequency output signal comprises an arbitrary pulse-shape.

8. The method according to claim 1, comprising dynamically adjusting a frequency of said local oscillator signal.

9. The method according to claim 1, wherein said bandpass filter comprises microstrip filters.

10. The method according to claim 1, wherein a phase-locked loop is used to generate said clock signal.

11. A system for processing communication signals, the system comprising:
one or more circuits, said one or more circuits enable:
generation of one or more digital output signals via a Direct Digital Frequency Synthesizer (DDFS) that is clocked by a high frequency clock signal;
conversion of said one or more generated digital output signals into an analog signal via a Digital-to-Analog Converter (DAC), wherein said analog signal comprises at least a local oscillator signal and a corresponding frequency image signal, and said DAC is clocked by said high frequency clock signal; and
generation of a low-frequency output local oscillator signal by bandpass filtering said analog signal in a single-pole bandpass filter, said single-pole bandpass filter is configured to retain said local oscillator signal component of said analog signal.

12. The system according to claim 11, wherein said one or more circuits programmably adjust an effective capacitance and/or an effective inductance of said single-pole bandpass filter.

13. The system according to claim 11, wherein said single-pole bandpass filter is a differential signal filter.

14. The system according to claim 13, wherein said one or more circuits generate said low-frequency output local oscillator signal as a differential signal.

15. The system according to claim 11, wherein said high frequency associated with said clock signal is at least 10 times higher than a fundamental frequency of said local oscillator signal associated with said low-frequency output local oscillator signal.

16. The system according to claim 11, wherein said low-frequency output signal is sinusoidal.

17. The system according to claim 11, wherein said low-frequency output signal comprises an arbitrary pulse-shape.

18. The system according to claim 11, wherein said one or more circuits dynamically adjust a frequency of said local oscillator signal.

19. The system according to claim 11, wherein said bandpass filter comprises microstrip filters.

20. The system according to claim 11, wherein a phase-locked loop is used to generate said clock signal.
